(19) United States
(12) Patent Application Publication
(10) Pub. No.: US 2010/0252712 A1
(43) Pub. Date: Oct. 7, 2010

(54) WIRE SHOCK MOUNT HAVING MOTION GUIDE AND ARTICLE HAVING THE SAME

(76) Inventor: DONG SEOG HA, ANYANG-SI (KR)

Correspondence Address: PARK LAW FIRM, 3255 WILSHIRE BLVD, SUITE 1110, LOS ANGELES, CA, 90010, US

(21) Appl. No.: 12/750,404

(22) Filed: Mar. 30, 2010

(30) Foreign Application Priority Data
Apr. 7, 2009 (KR) 10-2009-0029699

(51) Int. Cl. F16M 13/00

(52) U.S. Cl. 248/603

(57) ABSTRACT

Disclosed is a wire shock mount having a motion guide and a use of the wire shock mount, the motion guide being formed between a pair of mount bodies to limit the movement of the mount bodies up and down only such that an elastic movement of the mount bodies occurred by a shock applied is directed up and down only without twist. In order that the pair of the mount bodies facing each other moves up and down only without any twist in the back and forth and left and right, a motion guide is formed between the mount bodies and an engagement is formed on an external surface of one of the mount bodies so that the mount body can be engaged to a location, position and article.

### BACKGROUND OF THE INVENTION

1. Field of the Invention

The invention relates to a wire shock mount having a motion guide and a use of the wire shock mount, and more particularly to a wire shock mount having a motion guide, that includes a pair of mount bodies facing each other and a motion guide to limit the motion between the pair of mount bodies up and down such that an elastic movement of the mount bodies occurred by a shock applied is directed up and down only without twist, and an article having the wire shock mount attached to enhance shock absorption feature.

2. Description of the Prior Art

A wire shock mount is shock absorption equipment that is widely used to protect equipments vulnerable to vibration such as communication equipment and test apparatus. The wire shock mount has an elastic wire connected between a pair of mount bodies so that, when a shock such as a vibration is transferred to one mount body, the wire absorbs the transferred shock and the other mount body has the minimum shock transferred. Therefore, equipment fixed to the other mount body may be protected from shock.

The wire shock mount in the art is formed of a pair of mount bodies facing each other with a predetermined distance between them and a plurality of wires that connects edges of the mount bodies as shown in FIG. 1. One mount body is fixed to a wall or a bottom of the building and the other mount body is fixed to equipment to be protected from a shock caused by a vibration, so that shock and vibration transferred through the wall or bottom are absorbed with the wires and the shock and vibration transferred to the equipment attached to the mount body is minimized, thereby protecting the equipment.

Especially, when the wire shock mount is formed in an apparatus that is severely moved like vehicle, the shock and vibration caused by the movement are sufficiently absorbed while the wires connected between a pair of mount bodies moves back and forth, up and down and left and right, so it could be usefully employed.

However, the wire shock mount in the art that was constructed to absorb shock and vibration effectively has wires formed between the mount bodies, which is moved back and forth, up and down and left and right. It is not easy for the wire shock mount to be applied to location, position or article that is to be moved in one direction and should not be moved back and forth and left and right since there is a damage if it moves back and forth and left and right, therefore its use is restricted.

### SUMMARY OF THE INVENTION

Therefore, it is an object of the invention to provide a wire shock mount having a motion guide such that a pair of mount bodies facing each other is moved up and down only according to shock and vibration transferred so as to be applied to various locations, positions and articles.

Another object of the invention is to provide a wire shock mount having a motion guide capable of being assembled and dissolved rapidly and simply so that the wire shock mount may be applied to various locations, positions and articles without being restricted to specific locations, positions and articles.

The objects may be accomplished by forming a motion guide between the pair of mount bodies such that the pair of mount bodies is moved up and down without being twisted back and forth and left and right, and forming an engagement on the external surface of one mount body and engaging the engagement to location, position and article to be aimed.

According to the wire shock mount of the invention, since the pair of mount bodies facing each other absorbs shock while it moves up and down only in a straight line, it can be widely used in location, position and article that should absorb the shock and vibration. Further, the wire shock mount can be engaged rapidly and simply using an engagement formed on an external surface of one of the mount bodies so that it may be changeably applied to various articles as a shock absorption instrument.

### BRIEF DESCRIPTION OF THE DRAWINGS

To fully understand the invention, preferred embodiments of the invention will be described with reference to the accompanying drawings.

FIG. 1 is a perspective view showing a construction of a wire shock mount in the art.

FIG. 2 is an exploded perspective view showing a construction according to the invention.

FIG. 3 is a perspective view showing a motion state of the invention.

FIG. 4 is a side view showing an engagement state of the invention.

FIGS. 5a to 5c are exploded perspective views showing a construction of a motion guide according to an embodiment of the invention.

FIG. 6 is a view showing an engagement state of a motion guide of the invention.

FIGS. 7a to 7c are perspective views showing a construction of an engagement device according to an embodiment of the invention.

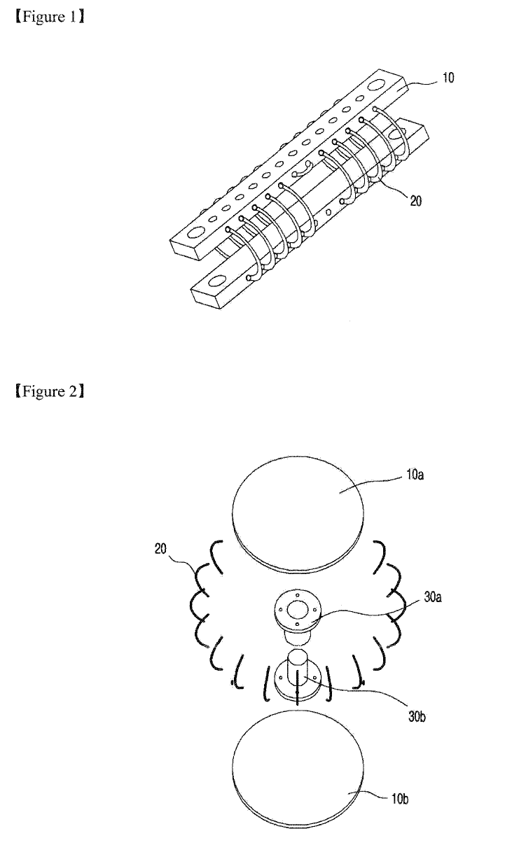

### DETAILED DESCRIPTION OF THE PREFERRED EMBODIMENT

To fully understand many objects to be accomplished by various embodiments and operational advantages of this invention, preferred embodiments of this invention will be described in a more detailed manner with reference to the attached drawings. In the attached drawings, like elements will be referred to as like numerals. Furthermore, the detailed technical explanation of already known functions and constructions will be omitted herein to avoid a faint determination of the subject matter of this invention.

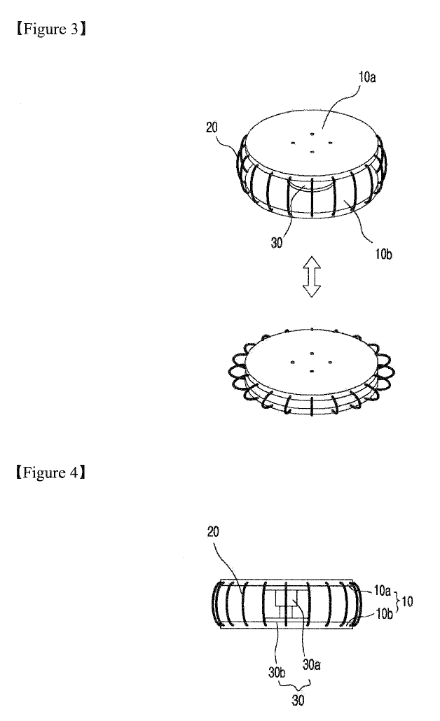

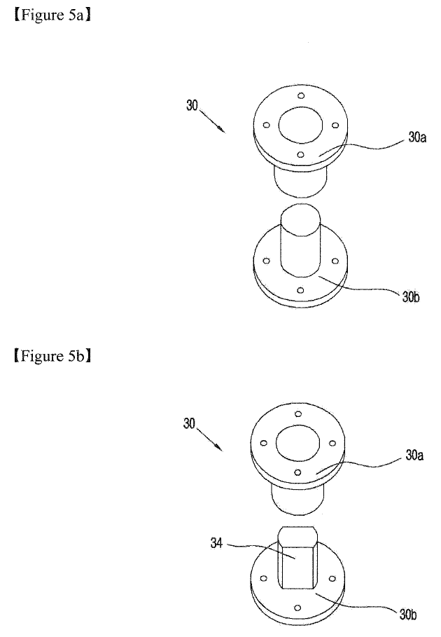

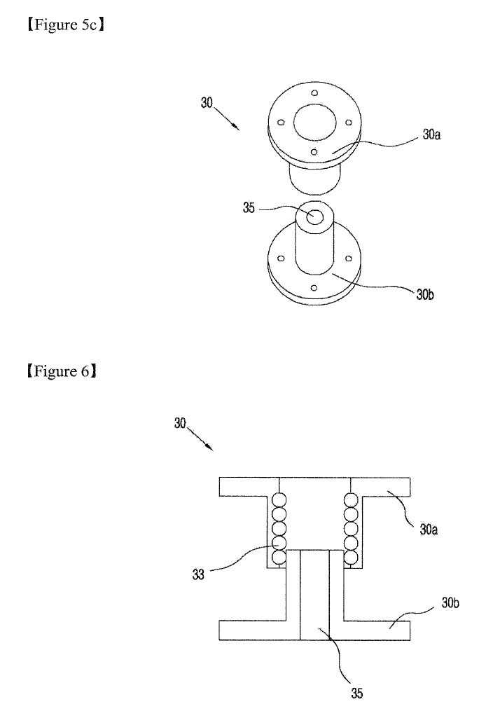

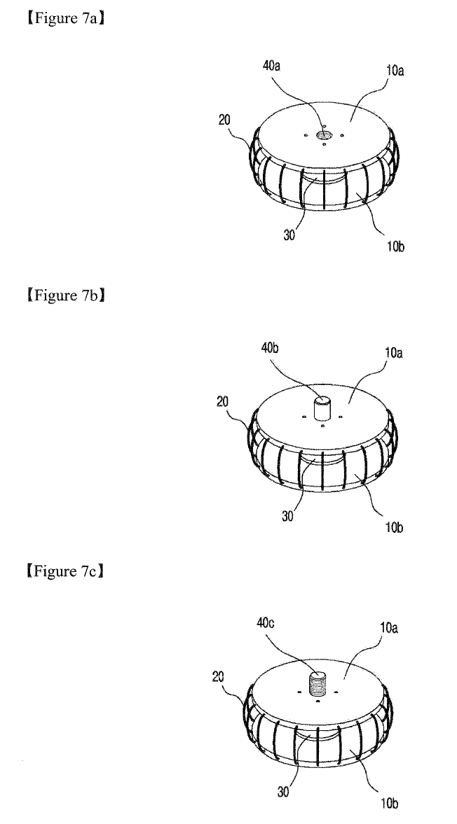

FIG. 2 is an exploded perspective view showing a construction of a wire shock mount according to the invention, and FIG. 3 is an engagement perspective view showing an engagement state of the invention.

Referring to the drawings, in a wire shock mount having a pair of mount bodies 10 separated each other in a predetermined distance and a plurality of wires 20 connected to the mount bodies so that shock and vibration transferred to one mount body is absorbed with the wires 20, a motion guide 30 is formed between the mount bodies 10, which directs the motion of the mount bodies 10 in a straight line without any twist.

At this time, the wire 20 is formed by twisting steel wires or synthetic resin, which is placed along the circumference of the mount bodies in a fixed space and externally formed in a curved shape. Accordingly, when space between the mount bodies 10 becomes narrow by an external force such as shock or vibration, the wires are smoothly bent so as to absorb the shock, and when the external force is released, the wires restore to the original state.

The motion guide 30 has a tube-shaped upper guide 30a and a tube-shaped lower guide 30b inserted into the tube-shaped upper guide 30a. Both guides 30a and 30b are vertically placed to be elevated freely and an end of the upper guide 30a is fixed to a lower surface of the upper mount body 10a and an end of the lower guide 30b is fixed to an upper surface of the lower mount body 10b so that an elastic movement between the mount bodies 10a and 10b can be performed in a straight line only.

At this time, a friction proof member 33 such as bearing or bushing is formed on an inner circumference surface of the upper guide 30a that is formed of a tube shape so that the lower guide 30b inserted into the upper guide 30a can be smoothly elevated according to a motion of the mount bodies 10a and 10b.

Further, in order to prevent the motion guide 30 from being poorly operated due to a compression caused by the elevation motion of the lower guide 30b inserted into the upper guide 30a, the lower guide 30b is cut in a length direction so as to form a cutting face 34 or an air discharge hole 35 is formed along an axis core of the lower guide 30b so as to perform a smooth elevation.

According to another embodiment of the invention, an engagement 40 is formed on the upper surface of the upper mount body 10a or the lower surface of the lower mount body 10b.

The engagement 40 is selectively formed on the upper mount body 10a and the lower mount body 10b, or formed on both of the mount bodies 10a and 10b.

The engagement 40 may be formed of a groove 40a, a projection 40b or a bolt 40c having screw threads.

Especially, the engagement 40 is used to make an engagement by engaging the projection 40b having screw threads on its one end to the groove 40a having screw threads on its inner circumference surface or engaging the bolt 40c to the groove 40a, so that the engagement 40 may be selectively formed on the locations, positions and articles to be used and used to make engagement.

The wire shock mount constructed as described above is operated as follows. That is, when vibration caused by shock or weight is transferred to location, position or article in which the wire shock mount is installed, a pair of mounts that is separated in a predetermined distance moves up and down along a movement line of the motion guide formed vertically, the separation distance becomes narrow and wires connecting mount bodies are bent so that shock is absorbed.

The wire shock mount having the motion guide that is constructed as described above is formed in a lower surface of a medical carrier to carry patients so that transportation of patents is safely performed since shock caused when transporting patents is absorbed. The wire shock mount may be attached to seats of vehicle so that passengers can be safely and comfortably by absorbing shock caused when driving. It may be installed on the lower surface of a mat in gymnasium such as Taekwondo center or Judo center so that a noise and a vibration can be reduced by releasing shock and a body of athlete can be protected. It is also used to absorb shock by attaching it to the bottom surface of an air board for sports, and to a seat portion of baby carriage so that shock caused when using the baby carriage may not be transferred to brain of baby. It can also be used in a bicycle so as to absorb shock occurred in a front portion of the bicycle like rear shock absorber or attached to a seat post under a saddle so as to absorb the shock of bottom.

The embodiments of the invention described above are merely examples, and it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A wire shock mount having a pair of mount bodies separated each other in a predetermined distance and a plurality of wires connected to the mount bodies so that shock and vibration transferred to one mount body is absorbed with the wires, comprising an motion guide that is formed between the mount bodies, which directs an motion of the mount bodies in a straight line without twist.

2. The wire shock mount according to claim 1, wherein the motion guide includes a tube-shaped upper guide fixed to a lower surface of the upper mount body and a lower guide fixed to an upper surface of the lower mount body and inserted into the upper guide.

3. The wire shock mount according to claim 2, wherein a friction release member including a bearing or a bushing is further formed on an inner circumference surface of the upper guide.

4. The wire shock mount according to claim 2, wherein the lower guide has cutting surfaces formed in a length direction of the lower guide.

5. The wire shock mount according to claim 2, wherein the lower guide further has air discharge holes formed along an axis core of the lower guide.

6. The wire shock mount according to claim 3, wherein the lower guide further has air discharge holes formed along the axis core of the lower guide.

7. The wire shock mount according to claim 4, wherein the lower guide further has air discharge holes formed along the axis core of the lower guide.

8. The wire shock mount according to claim 1, wherein an engagement is further formed on an external surface of the mount body.

9. The wire shock mount according to claim 6, wherein the engagement is formed of a groove, a projection or a bolt having screw threads.

10. The wire shock mount according claim 6, wherein the engagement is formed by forming screw threads on an inner circumference surface of the groove and forming screw threads on one end of the projection or bolt such that the groove and the projection or bolt may be engaged.

11. The wire shock mount according to claim 7, wherein the engagement is formed by forming screw threads on an inner circumference surface of the groove and forming screw threads on one end of the projection or bolt such that the groove and the projection or bolt may be engaged.

12. A medical carrier constructed including a wire shock mount having a motion guide according to claim 1.

13. A medical carrier constructed including a wire shock mount having a motion guide according to claim 2.

14. A car seat constructed including a wire shock mount having a motion guide according claim 1.

15. A car seat constructed including a wire shock mount having a motion guide according claim 2.

16. An air board for sports constructed including a wire shock mount having a motion guide according claim 1.

17. An air board for sports constructed including a wire shock mount having a motion guide according claim 2.

18. A baby carriage constructed including a wire shock mount having a motion guide according claim 1.

19. A baby carriage constructed including a wire shock mount having a motion guide according claim 2.

20. A bicycle constructed including a wire shock mount having a motion guide according claim 1.

21. A bicycle constructed including a wire shock mount having a motion guide according claim 2.
